(19) United States
(12) Patent Application Publication
(10) Pub. No.: US 2014/0317170 A1
(43) Pub. Date: Oct. 23, 2014

(54) Automatic generation of M2M network applications

(71) Applicants: Robbin Hughes, Plano, TX (US); Thomas O'Neill, La Jolla, CA (US); Prem Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Prem Jothipragasam Kumar, San Diego, CA (US); Ramesh Rajasekaran, Chennai (IN)

(21) Appl. No.: 13/868,556

(22) Filed: Apr. 23, 2013

(51) Int. Cl. H04L 29/06

(52) U.S. Cl. CPC H04L 67/42
USPC 709/203

(57) ABSTRACT

The proposed embodiment provides a method and system for automatically generating machine to machine (M2M) network applications. The method and system includes receiving information about one or more nodes in the network and generating one or more applications for the one or more nodes based on the information.

### TECHNICAL FIELD

The embodiments herein relate to network management systems and, more particularly, for generating machine to machine (M2M) applications in a M2M network management system.

### BACKGROUND

Modern machine to machine (M2M) communications has expanded beyond a one-to-one connection and changed into a system of M2M networks. The M2M networks generally implement a dynamic topology in which devices are associated and disassociated with each other. The roles and responsibilities of each such device may change over time and there remain unique challenges to developing, deploying, and managing the M2M networks.

Different systems and methods are proposed to develop, deploy, and manage devices and its associations in the M2M networks. The existing systems and methods use a back-end server to perform development, deployment, configuration, and management of the devices in the M2M network. The back-end server includes a web application using configuration tables, which provides limited information about the devices and overall M2M network. Further, reconfiguration of the devices includes manual configuration operation or a combination of manual intervention with limited computer-generated reconfiguration.

### BRIEF DESCRIPTION OF THE FIGURES

The embodiments herein will be better understood from the following detailed description with reference to the drawings, in which:

FIG. 1 illustrates generally, among other things, a system in which the present embodiment is embodied, according to embodiments described herein;

FIG. 2 expands features and functions of the system as described in the FIG. 1, according to embodiments described herein;

FIG. 3 is an example web based interface of M2M network topology, according to embodiments described herein;

FIG. 4 is a sequence diagram illustrating generally operations performed by server as described in the FIG. 2, according to embodiments disclosed herein;

FIG. 5 is a sequence diagram illustrating generally operations performed by the system in communication with an administrator, according to embodiments disclosed herein; and

FIG. 6 is a flowchart illustrating generally a method for automatically generating machine to machine network applications, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for automatically generating machine to machine (M2M) network applications. A central server can be configured to monitor the information about one or more nodes in the M2M network. The server includes network analysis tools to analyze the information about the nodes and display a visual representation of the M2M network. The visual representation allows a user to perform add, delete, modify, switch, configure, reconfigure, arrange, move, or any other action in the M2M network. The server uses the network analysis tools to automatically generate applications for each node present in the M2M network. Further, the server is configured to automatically generate applications or reconfigure the entire network based on the user actions performed via the visual representation of the M2M network.

The proposed system and method is simple, reliable, and robust for automatically generating M2M network applications. The main advantage of the proposed embodiment is to analyze, plot, evaluate, configure, and reconfigure the entire M2M network and automatically generate required configuration software's, applications, drivers, patches, add-ins, plug-ins, and configuration files throughout the M2M network. Error-free and fast configurations/reconfigurations can be performed compared to manual and semi-manual configurations/reconfigurations of the M2M networks. The system and method is used to constantly monitor and optimize the M2M network to increase performance with less cost and to increase availability of resources in the network. Administrators can easily try various network topologies in simulation using the visual representation of the M2M network and can easily reach to an optimal solution.

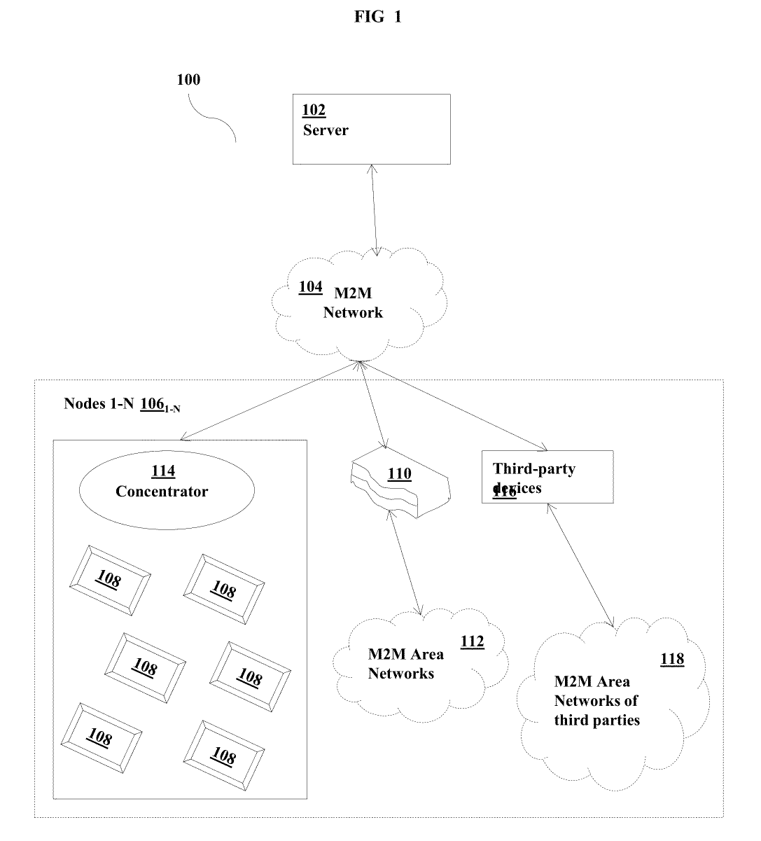

Referring now to the drawings, and more particularly to FIGS. 1 through 6, where similar reference characters denote corresponding features consistently throughout the figures, there are shown embodiments.

FIG. 1 illustrates generally, among other things, a system 100 in which the present embodiment is embodied, according to embodiments described herein. The system 100 can provide a complete solution including a server 102 (also referred as M2M server 102), M2M network(s) 104, and a plurality of nodes 106_{1-N} (hereafter referred as nodes 106). The nodes 106 described herein can include for example, but not limited to, M2M devices (for example, the devices 108), M2M gateways (for example, the gateway 110) and associated networks (for example, the M2M area network 112), concentrators (for example, the devices 114), third-party service providers (for example, the third-party devices 116) and associated networks (for example, the M2M area networks of third-parties 118), and various other networks sources (not shown) such as routers, hubs, collectors, sensors, meters, back-up server(s), storage devices, and the like. In an embodiment, the M2M network(s) 104 described herein can include for example, but not limited to, wireless network, wire line network, cellular network, personal network, private network, public network such as the Internet, local area network (LAN), wide area network (WAN), metropolitan area network (MAN), global system for mobile communications (GSM) network, or a combination thereof.

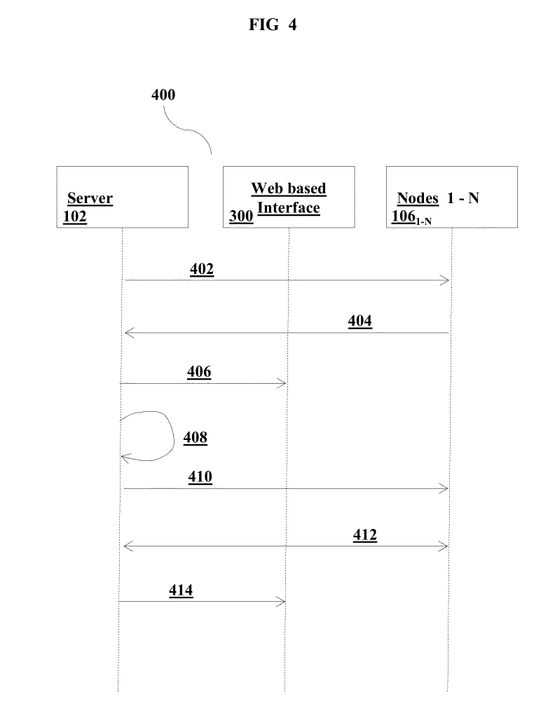

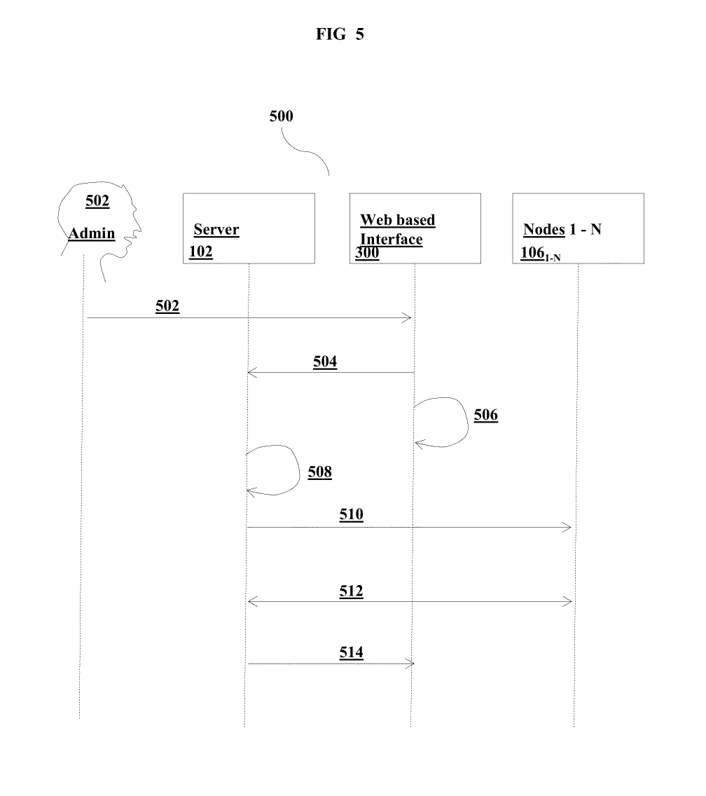

In an embodiment, the server 102 can be configured to capture information about the nodes 106 over the M2M network 106. The server 102 can be configured to interact with multiple concentrators (or any other collector devices) or can directly interface with the nodes 106 to capture the information. The information captured by the server 102 can include for example, but not limited to, each node IP address, MAC address, changes in network states such as new nodes registering, nodes unregistering, node paths changing, traffic associated with the nodes, multiple routes and paths associated with each node, and the like. The captured information is maintained by the server 102. Further, the server 102 can be configured to include or couples to one or more databases describing current state information of the each node and the historical states of each node in the M2M network. The historical states information of the system 100 can be used to reconstruct the network topology at any particular point. An exemplary sequence of events resulting in a change in the network topology is described in conjunction with the FIGS. 4 and 5.

In an embodiment, hierarchical integration of the system 100 can allow functionality to reside closer to involved nodes, while at the same time enabling optimizations in both network signaling load and data storage. In an embodiment, the nodes and the network registration information can be mirrored, shared, or coordinated within the system 100 so as to alleviate the network signaling load.

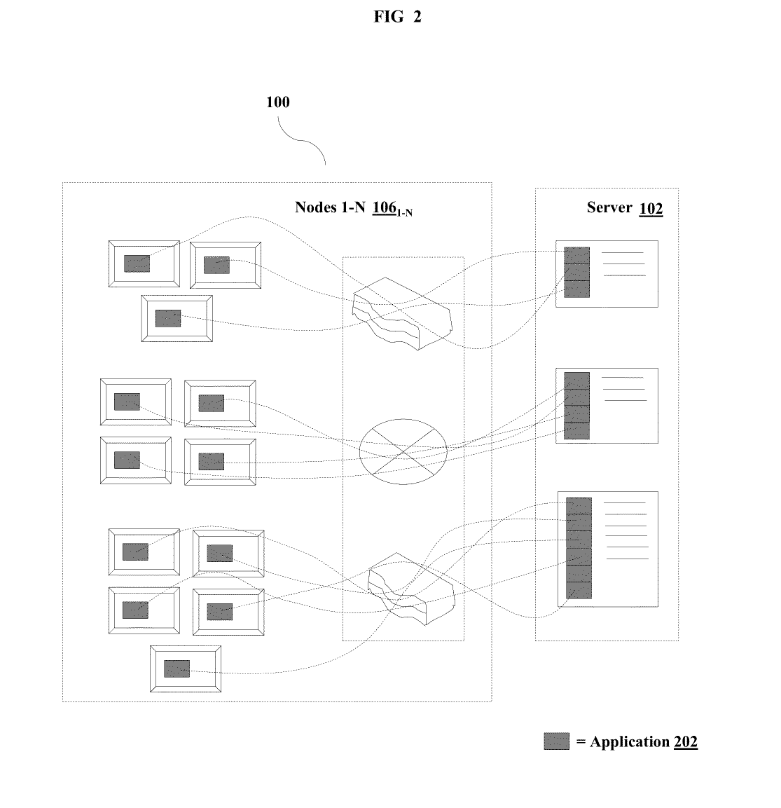

FIG. 2 expands features and functions of the system 100 as described in the FIG. 1, according to embodiments described herein. The server 102 can be configured to collect the information about the nodes 106 in the M2M network 104. In an example, the server 102 can be configured to analyze the collected information and generate applications (for example, the application 202 as shown in the FIG. 2) for each node in the M2M network 104. In an embodiment, the server 102 can be configured to implement or include network analysis tools to analyze the collected information and generate appropriate applications for each node in the M2M network 104.

As shown in the FIG. 2, the server 102 can be configured to generate appropriate configuration applications for each node present in the M2M network 104 based on the received information. In an embodiment, the term “application” described herein can include for example, but not limited to, network configuration software's, driver applications, patches, add-ins, plug-ins, configuration files, and the like. The server 102 can be configured to generate the applications 202 and includes total control over the operations performed on the nodes 104 via the applications 202. The server 102 can manage and maintain the appropriate configuration of applications and links associated among the nodes 106 in the M2M network 104. For example, the system 100 allows the server 102 to automatically connect configured short-range links to appropriate M2M sensors or the system 100 can automatically connect the appropriate backhaul links from the server 102 to the appropriate M2M traffic concentrators. Further, the server 102 can be configured to continuously monitor each node in the network 104 and optimize the M2M network such as to increase network performance, availability of resources, and decrease cost of the system 100.

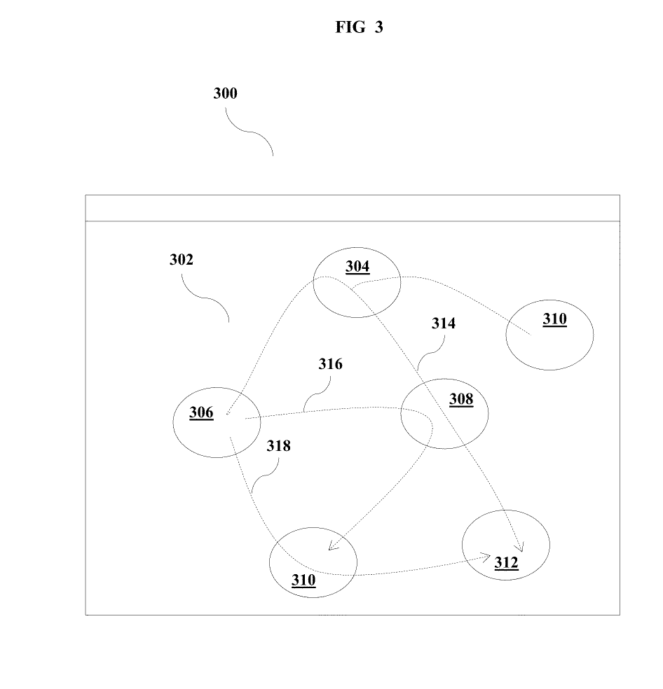

Further, the server 102 can be configured to provide a standard and easy-to-use interface such as to manage the M2M network 104 and associated configurations. An exemplary graphical interface generated by the server 102 is described in conjunction with the FIG. 3.

FIG. 3 shows an example web based interface 300 of a M2M network topology according to embodiments described herein. The server 102 can be configured to use the network analysis tools such as to analyze the information collected from the nodes 104 and generate a visual representation 302 of the network topology. A simple six node network, with node 304 representing a top of a device tree and having three sub-nodes 306, 308, and 310 respectively is shown in the FIG. 3. The node 308 in turn has sub-nodes 312 and 314 respectively. The six nodes in a tree structure represent the nodes visual representation 302.

The links/paths associated to reach each node are stored in the system 100. As shown in the FIG. 3 each node defines the path/link associated with it. Each link/path is depicted as, 314, 316, and 318 respectively. Three paths are overlaid on the visual representation 302. The path 314 defines a path from the node 306 to the node 304 to the node 308 to the node 312. The path 316 defines a path from the node 306 to the node 308 to the node 310 and the path 318 defines a path from the node 306 to the node 310 to the node 312. In an embodiment, multiples links or paths from source node to the destination node can exists in the network and can be represented in the visual representation 302 by the server 102.

The baseline visualization represents the two-dimensional topology of the M2M network as described in the visual representation 302. The topology may comprise a star, tree, mesh, hierarchical, or a combination thereof. Regardless of the structure, the network topology represents the devices in the network and the associations between them. In an embodiment, the server 102 can allow an administrator or any other user/network analyst to perform actions on the visual representation 302 using the web based interface 300. The administrator can manage network topology by using the visual representation 302 of the network. In an embodiment, the administrator can use the web based interface 300 to perform add, delete, modify, change, arrange, switch, configure, reconfigure, and the like actions on the visual representation 302. In an embodiment, the administrator can simply drag and drop devices or links in the network topology to manage the network. Further, the server 102 can be configured to automatically reconfigure and generate/update appropriate applications for each node in the network based on the administrator actions. In an embodiment, the server 102 can be configured to update the visual representation 302 in response to detecting changes in the network configuration and topology based on the administrator actions or commands. In an embodiment, the server 102 can constantly monitors the entire network status such as to constantly update the visual representation and applications associated with each node in the network.

In one embodiment, the visual representation 302 described herein provides the basis for visualizing the result of the network analysis and should not be considered as limiting the scope of the embodiment. The visual representation 302 depicts formal associations and may also facilitate the processing of network layer analysis.

FIG. 4 is a sequence diagram illustrating generally operations 400 performed by the server 102 as described in the FIG. 2, according to embodiments disclosed herein. At 402, the server 102 can be configured to collect information about the nodes 106. In an example, the server 102 can send a request to each individual node in the M2M network 104. The information received from the nodes 104 can include for example, but not limited to, each node IP address, MAC address, changes in network states such as new nodes registering, nodes unregistering, node paths changing, traffic associated with the nodes, multiple routes and paths associated with each node, and the like.

In an embodiment, at 404, the nodes 106 can be configured to provide information associated with it. In an example, providing information associated with the nodes 106 can involve privacy concerns, such as transmitting the information of the nodes 106 over the M2M network 106 (or any third-party applications, devices, and networks). Options are available to address privacy concerns. The options may include that an administrator or security applications may be chosen to opt-in to participate or to opt-out to not participate in monitoring or sharing of the information associated with the nodes 106.

In an embodiment, at 406, the server 102 can be configured to display a visual representation of the network via the web based interface 300. In an example, the server 102 can use one or more network analysis tools to analyze the information received from the nodes 106 and generate the visual representation of the network. The visual representation described herein can allow an administrator or any user to perform one or more actions to manage the network topology.

In an embodiment, at 408, the server 102 can be configured to generate applications for each node in the network based on the received information. In an example, the server 102 can use the one or more network analysis tools to generate appropriate applications for each node in the network. The applications described herein can include network configuration software's, driver applications, patches, add-ins, plug-ins, configuration files, and the like.

In an embodiment, at 410, the server 102 can be configured to provide the generated applications to the nodes 106. In an example, the server 102 can automatically download and install the generated applications on each node of the system 100. The server 102 can automatically connect, disconnect, associate, or disassociate any links, paths, nodes, and the like based on the received information.

In an embodiment, at 412, the server 102 can be configured to constantly monitor each node in the M2M network and automatically deploy, develop, manage, configure, reconfigure, and generate applications (or other settings) in the network. At 414, the server 102 can be configured to update the visual representation and applications of the network in response to determining any change or update in the network.

The operations, steps, blocks, units, and acts described with respect to the FIG. 4 are preferably automatic and may not require any type of user intervention. In this way, the system maintains a substantially up to date description of each node in the network.

FIG. 5 is a sequence diagram illustrating generally operations 500 performed by the system 100 in communications with an administrator 502, according to embodiments disclosed herein. In an embodiment, at 504, the administrator 502 use the web based interface 300 to access the network topology. The administrator 502 can perform various actions on the visual representation to manage, change, configure, or reconfigure the network topology. In an example, the administrator 502 can use the web based interface 300 to perform view, add, delete, modify, change, arrange, configure, reconfigure, and the like actions on the visual representation of the network. In an example, the administrator 502 can simply drag and drop devices or links in the network topology to manage the network. In an example, the administrator 502 can provide any command to perform the actions to manage the network.

In an embodiment, at 504, the various actions performed by the administrator 502 can be monitored by the server 102. In an example, the server 102 stores the various actions performed by the administrator 502 on the network topology and automatically reconfigure the network topology.

In an embodiment, at 506, the server 102 can be configured to update or regenerate the display of the visual representation of the network based on the actions performed by the administrator. In an example, the server 102 can use the one or more network analysis tools to analyze the actions performed by the administrator 502 and update the visual representation of the network.

In an embodiment, at 508, the server 102 can update or regenerate applications for each node in the network based on actions performed by the administrator 502. In an example, the server 102 can use the one or more network analysis tools to update or regenerate the applications for each node in the network. In an example, the applications described herein can include network configuration software's, driver applications, patches, add-ins, plug-ins, configuration files, and the like.

In an embodiment, at 510, the server 102 can provide the updated or regenerated applications to the nodes 106. In an example, the server 102 can automatically download and install the generated applications on each node in the network. Further, the server 102 can automatically connect, disconnect, associate, or disassociate any links, paths, nodes, and the like based on the actions performed by the administrator 502.

In an embodiment, at 512, the server 102 can be configured to constantly monitor the administrator actions 502 and automatically deploy, develop, manage, configure, reconfigure, and generate applications (or other settings) in the network. At 514, the server 102 can be configured to update or regenerate the visual representation and applications of the network in response any actions performed by the administrator 502.

The various operations, acts, or steps described with respect to the FIGS. 4 and 5 can be performed in the order present, simultaneously, parallel, combination thereof, or in any order. The operations, acts, or steps herein are only for illustrative purpose and do not limit the scope of the embodiment. Further, in some embodiments some of the operations, acts, or steps can be added, skipped, omitted, or modified without departing from the scope of the embodiment.

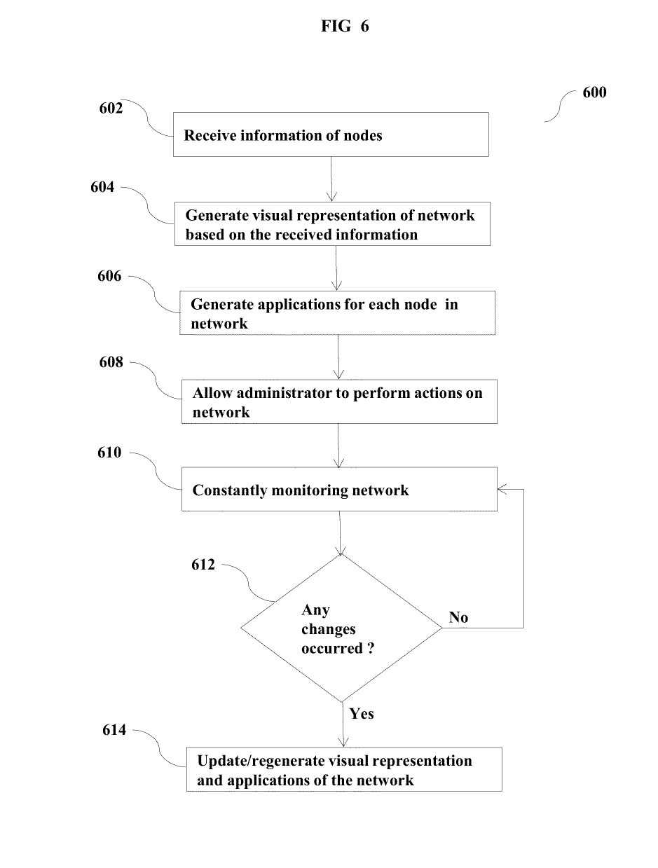

FIG. 6 is a flowchart illustrating generally a method 600 for automatically generating machine to machine network applications, according to embodiments disclosed herein. In an embodiment, at 602, the method 600 includes receiving information of one or more nodes. In an example, the method 600 allows the server 102 sends a request to each individual node in the M2M network. The information received from the nodes can include for example, but not limited to, each node IP address, MAC address, changes in network states such as new nodes registering, nodes unregistering, node paths changing, traffic associated with the nodes, multiple routes and paths associated with each node, and the like.

In an embodiment, at 604, the method 600 includes generating a visual representation of the network based on the received information. In an example, the method 600 allows the server 102 to use one or more network analysis tools to analyze the information received from the nodes and generate the visual representation of the network. Further, the visual representation can allow the administrator 502 (or any other user) to perform one or more actions such as to manage the network topology.

In an embodiment, at 606, the method 600 includes generating applications for each node in the network. In an example, the method 600 allows the server 102 use the one or more network analysis tools to generate appropriate applications for each node in the network based on the received information. The applications described herein can include network configuration software's, driver applications, patches, add-ins, plug-ins, configuration files, and the like. In an example, the method 600 allows automatically download and install the generated applications on each node of the network. Further, the server 102 automatically connects, disconnect, associate, or disassociate any links, paths, nodes, and the like based on the received information.

In an embodiment, at 608, the method 600 includes allowing the administrator 502 (or any user) to perform actions on the network. In an example, the administrator 502 uses the web based interface 300 to perform view, add, delete, modify, change, arrange, configure, reconfigure, and the like actions on the visual representation of the network. In an example, the administrator 502 can simply drag and drop devices or links in the network topology to manage the network.

In an embodiment, at 610, the method 600 includes constantly monitor each in the network. In an example, the method 600 allows the server 102 to monitor the actions performed by the administer 502 or any other changes occurred in the network.

In an embodiment, at 612, the method 600 includes determining if any changes occurred in the network. Further, at 612, the method 600 includes updating/regenerating the visual representation and the applications of the network in response to determining a change in the network. The method 600 further allow the server 102 to automatically connect, disconnect, associate, or disassociate any links, paths, nodes, and the like based on the changes detected in the network. In an embodiment, the method 600 allows the server 102 to continue monitoring the network and automatically deploy, develop, manage, configure, reconfigure, and generate applications for each node in the network.

The various steps, acts, blocks, units, and actions of the method 600 may be performed in the order presented, in a different order or simultaneously. Further, in some embodiments, some actions listed in the FIG. 6 may be omitted, added, or skipped without departing from the scope of the embodiment.

The embodiments disclosed herein can be implemented through at least one software program running on at least one hardware device and performing network management functions to control the network elements. The network elements shown in FIGS. 1 through 3 include blocks which can be at least one of a hardware device, or a combination of hardware device and software module.

The embodiment disclosed herein specifies a system for automatically generating machine to M2M network applications. The mechanism allows receiving the network information and automatically generating graphical user interface, a visual representation, and application configurations for each node in the network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A system for automatically generating machine to machine (M2M) network applications, the system comprising a server configured to:
receive information about at least one node in said network, and
generate at least one application for said at least one node based on said information.

2. The system of claim 1, wherein said at least one application comprises at least one of configuration software, driver, patch, add-in, plug-in, configuration file, and setting for said at least one node of said network.

3. The system of claim 1, wherein said server is further configured to automatically install said at least one application on said at least one node of said network.

4. The system of claim 1, wherein said system further comprises at least one concentrator to monitor said information of said at least one node.

5. The system of claim 1, wherein said server is further configured to generate a visual representation of said network based on said information.

6. The system of claim 5, wherein said visual representation is configured to allow a user to perform at least one action.

7. The system of claim 6, wherein said at least one action comprises at least one of adding, modifying, deleting, switching, reconfiguring, and moving said at least one node in said network.

8. The system of claim 5, wherein said server is configured to automatically regenerate said visual representation in response to said at least one action performed by said user.

9. The system of claim 5, wherein said server is further configured to automatically update said at least one application for said at least one node in response to said at least one action performed by said user.

10. A method for automatically generating machine to machine (M2M) network applications, the method comprising:
receiving information about at least one node in said network, and
generating at least one application for said at least one node based on said information.

11. The method of claim 10, wherein said at least one application comprises at least one of configuration software, driver, patch, add-in, plug-in, configuration file, and setting for said at least one node of said network.

12. The method of claim 10, wherein said method further comprises automatically installing said at least one application on said at least one node of said network.

13. The method of claim 10, wherein said method further comprises generating a visual representation of said network based on said information.

14. The method of claim 13, wherein said visual representation allows a user to perform at least one action.

15. The method of claim 14, wherein said at least one action comprises at least one of adding, modifying, deleting, switching, reconfiguring, and moving said at least one node in said network.

16. The method of claim 13, wherein said method further comprises automatically regenerating said visual representation in response to said at least one action performed by said user.

17. The method of claim 10, wherein said method further comprises automatically updating said at least one application for said at least one node in response to said at least one action performed by said user.
